(19) United States
(12) Patent Application Publication
(10) Pub. No.: US 2013/0173830 A1
(43) Pub. Date: Jul. 4, 2013

(54) Synchronization of Data Delivery in Control Systems

(71) Applicants: Vijay Vallala, North Andover, MA (US); Suad Mohamed, Acton, MA (US); Steve Webster, Raymond, NH (US)

(72) Inventors: Vijay Vallala, North Andover, MA (US); Suad Mohamed, Acton, MA (US); Steve Webster, Raymond, NH (US)

(21) Appl. No.: 13/339,825

(22) Filed: Dec. 29, 2011

(51) Int. Cl. G06F 13/14

(52) U.S. Cl. 710/33

(57) ABSTRACT

An enhanced synchronized communication device within a control system may allow output data delivered to various input/output (I/O) devices to be synchronized to the time at which the output data has been generated by a programmable logic controller (PLC). In this scheme, a central processing unit (CPU) associated with the PLC may generate and transmit output data to the enhanced synchronized communication device. When the output data arrives at the enhanced synchronized communication device, the enhanced synchronized communication device may associate the output data to a trigger mechanism (e.g., the application trigger feature of Common Industrial Protocol, etc.) for immediately triggering the transfer of the output data to the I/O devices. This process may remove possible jitter associated with output data delivery in control systems.

### TECHNICAL FIELD

Aspects of the disclosure generally relate to methods and systems for the delivery of output data to input/output (I/O) devices immediately after the data has been generated by a processor associated with a programmable logic controller (PLC) in a control network.

### BACKGROUND

Typically, programmable logic controllers (PLCs) include a central processing unit (CPU) that serves as a master for processing input data (e.g., sensor data from various input/output (I/O) devices, etc.) and for delivering output data (e.g., I/O commands generated via a PLC scan service, etc.) to a communications module (the COM module). The COM module may include an I/O scanner service for reading input data from the I/O devices (e.g., sensors, switches, etc.) so that the data can be forwarded to the CPU and for conveying the output data from the CPU to the appropriate I/O devices.

In traditional control systems, the CPU and COM module run asynchronously. For instance, the COM module may be configured to send output data to various I/O devices at a predetermined frequency (e.g., every second, etc.), irrespective of when new output data are delivered from the CPU to the COM module. Meanwhile, the PLC may process input data (e.g., data received through the COM module) from I/O devices and generate output data in real-time. Thus, there may be a delay between the time at which a PLC transmits output data to the COM module and the time at which the COM module relays the output data to the appropriate I/O devices.

FIG. 1 shows a conventional PLC system in which both the CPU and COM module run asynchronously. In FIG. 1, CPU 101 and COM module 103 are shown as separate hardware components. CPU 101 transmits output data to the COM module 103 at times 105 whereas the COM module 103 eventually relays this output data to the appropriate I/O devices at times 107. Times 107 may be based on preconfigured cycle time 109 of COM module 103, resulting in varying amounts of delay between the time at which the output data are initially received by COM module 103 and the time at which COM module 103 forwards the output data to the appropriate I/O devices (not shown).

Thus, conventional control system methodologies may result in delayed or outdated information being propagated to I/O devices. As such, new systems and methods are required to avoid this delay.

### BRIEF SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the disclosure address one or more of the issues mentioned above by disclosing methods, non-transitory computer readable media, and apparatuses for synchronizing output data generated by a programmable logic controller (PLC) with the delivery of that output data to input/output (I/O) devices within a control system.

Other aspects of the disclosure relate to associating an application trigger implemented through Common Industrial Protocol (CIP) with the generation of output data to allow a communications module (COM module) to immediately deliver output data to I/O devices.

Aspects of the disclosure may be provided in a computer-readable medium having computer-executable instructions that, when executed, cause a computer or other apparatus to perform one or more of the process steps described herein.

### BRIEF DESCRIPTION OF THE DRAWINGS

The example embodiments are illustrated by way of example in the accompanying figures in which:

FIG. 1 shows a conventional programmable logic controller (PLC) system in which both a central processing unit (CPU) and a communications module (COM module) run asynchronously.

FIG. 2 shows an illustrative operating environment in which various aspects of the disclosure may be implemented.

FIG. 3 is an illustrative block diagram of an enhanced synchronized communication device and other network devices that may be used to implement the processes and functions of one or more aspects of the present disclosure.

FIG. 4 shows a diagram of a control system for synchronizing the delivery of output data to input/output (I/O) devices with the generation of this output data by a central processing unit (CPU) associated with a programmable logic controller (PLC), in accordance with one or more aspects of the disclosure.

FIG. 5 shows an example flow diagram of steps performed for synchronizing the delivery of output data to input/output (I/O) devices with the generation of this output data by a central processing unit (CPU) associated with a programmable logic controller (PLC), in accordance with one or more aspects of the disclosure.

### DETAILED DESCRIPTION

As described above, conventional control systems use asynchronous timing schemes that may result in delayed or outdated data being communicated to input/output (I/O) devices. To overcome this and other problems, the example embodiments of this disclosure provide novel methodologies to synchronize the delivery of output data to I/O devices immediately after the central processing unit (CPU) within a programmable logic controller (PLC) has generated responsive output data.

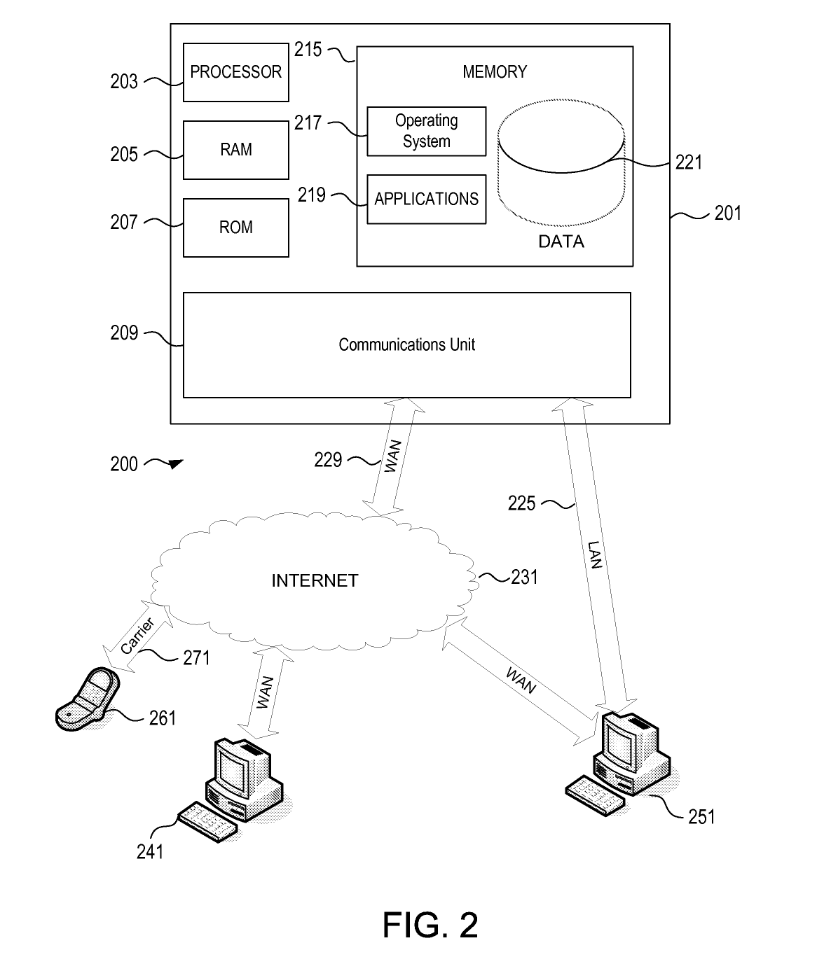

FIG. 2 illustrates an exemplary computing system environment 200 that may be used according to one or more illustrative embodiments. The computing system environment 200 is only one example of a suitable computing environment and is not intended to suggest any limitation as to the scope of use or functionality contained in the disclosure. The computing system environment 200 should not be interpreted as having any dependency or requirement relating to any one or combination of components shown in the illustrative computing system environment 200.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 2, the computing system environment 200 may include an enhanced synchronized communication device 201 wherein the processes discussed herein may be implemented. The device 201 may have a processor 203 for controlling overall operation of the device 201 and its associated components, including random-access memory (RAM) 205, read-only memory (ROM) 207, communications unit 209, and memory 215. In some aspects, enhanced synchronized communication device 201 may be associated with an automation control system that includes various I/O devices and programmable logic controllers (PLCs). Processor 203 and its associated components may allow the device 201 to run a series of computer-readable instructions related to detecting when a central processing unit (CPU) of a PLC has generated output data. Processor 203 may also direct device 201 to forward output data to the appropriate input/output (I/O) devices.

Device 201 typically includes a variety of computer readable media. Computer readable media may be any available media that may be accessed by communication device 201 and include both volatile and nonvolatile media, removable and non-removable media. By way of example, and not limitation, computer-readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by device 201.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection (e.g., Ethernet, etc.), and wireless media such as acoustic, RF, infrared and other wireless media.

Although not shown, RAM 205 may include one or more applications representing the application data stored in RAM 205 while the device 201 is on and corresponding software applications (e.g., software tasks) are running on the device 201.

Communications unit 209 may include a microphone, keypad, touch screen, and/or stylus through which a user of device 201 may provide input, and may also include one or more of a speaker for providing audio output and a video display device for providing textual, audiovisual and/or graphical output.

Software may be stored within memory 215 and/or storage to provide instructions to processor 203 for enabling device 201 to perform various functions. For example, memory 215 may store software used by the device 201, such as an operating system 217, application programs 219, and an associated database 221. Also, some or all of the computer executable instructions for device 201 may be embodied in hardware or firmware.

Device 201 may operate in a networked environment supporting connections to one or more remote computing devices, such as computing devices 241, 251, and 261. The computing devices 241, 251, and 261 may be computing devices or servers that include many or all of the elements described above relative to the enhanced synchronized communication device 201. Computing device 261 may be a mobile device communicating over wireless carrier channel 271.

The network connections depicted in FIG. 2 include a local area network (LAN) 225 and a wide area network (WAN) 229, but may also include other networks. When used in a LAN networking environment, device 201 may be connected to the LAN 225 through a network interface or adapter in the communications unit 209. When used in a WAN networking environment, device 201 may include a modem in the communications unit 209 or other means for establishing communications over the WAN 229, such as the Internet 231 or other type of computer network. It will be appreciated that the network connections shown are illustrative and other means of establishing a communications link between the devices may be used. Various well-known protocols such as TCP/IP, Ethernet, FTP, HTTP, EtherNet/IP, Modbus TCP, 5908, PROFIBUS, DeviceNet, Common Industrial Protocol (CIP), and the like may be used, and the system can be operated in a client-server configuration to permit a user to retrieve web pages from a web-based server. Any of various conventional web browsers can be used to display and manipulate data on web pages.

Additionally, one or more application programs 219 used by the device 201, according to an illustrative embodiment, may include computer executable instructions for invoking functionality related to associating an application trigger feature with the generation of output data by a PLC CPU and/or with the completion of an output cycle for the PLC. In addition, the application programs 219 may include computer executable instructions for invoking functionality related to detecting when the PLC output cycle has been completed.

Embodiments of the disclosure may include forms of computer-readable media. Computer-readable media include any available media that can be accessed by device 201. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor 203 on enhanced synchronized communication device 201. Such a processor may execute computer-executable instructions stored on a computer-readable medium.

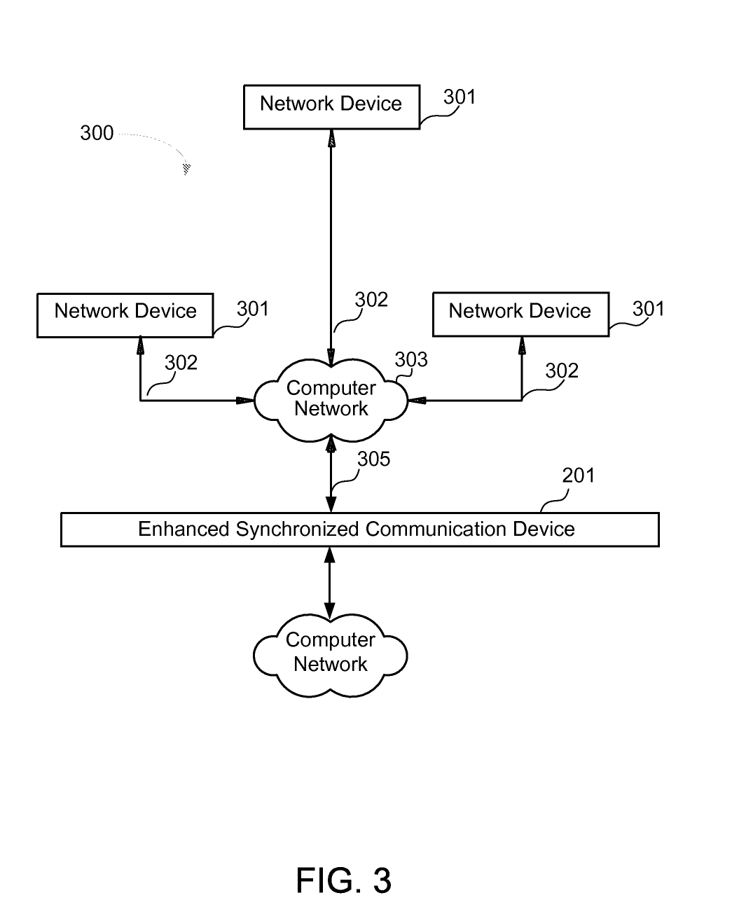

Referring to FIG. 3, an illustrative system 300 for implementing example embodiments according to the present disclosure is shown. As illustrated, system 300 may include one or more network devices 301. Network devices 301 may be local or remote, and may be connected by one of communications links 302 to computer network 303 that is linked via communications links 305 to an enhanced synchronized communication device 201. Network devices 301 may include many of the same hardware/software components as enhanced synchronized communication device 201. In some embodiments, network devices 301 may represent low level I/O devices (e.g., switches, sensors, motors, etc.) within an automation control system. In other embodiments, network devices 301 may represent computing devices (e.g., PLCs, servers, etc.) that exchange information within network 303. In system 300, enhanced synchronized communication device 201 may be any suitable server, processor, computer, or data processing device, communication module, or combination of the same. Enhanced synchronized communication device 201 may be used to process the instructions received from one or more users or one or more network devices 201. For instance, enhanced synchronized communication device 201 may receive a message from a network device 301 via the Common Industrial Protocol (CIP) regarding the completion of an output cycle for device 301.

Computer network 303 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 302 and 305 may be any communications links suitable for communicating between network devices 301 and enhanced synchronized communication device 201, such as network links, dial-up links, wireless links, hard-wired links, etc.

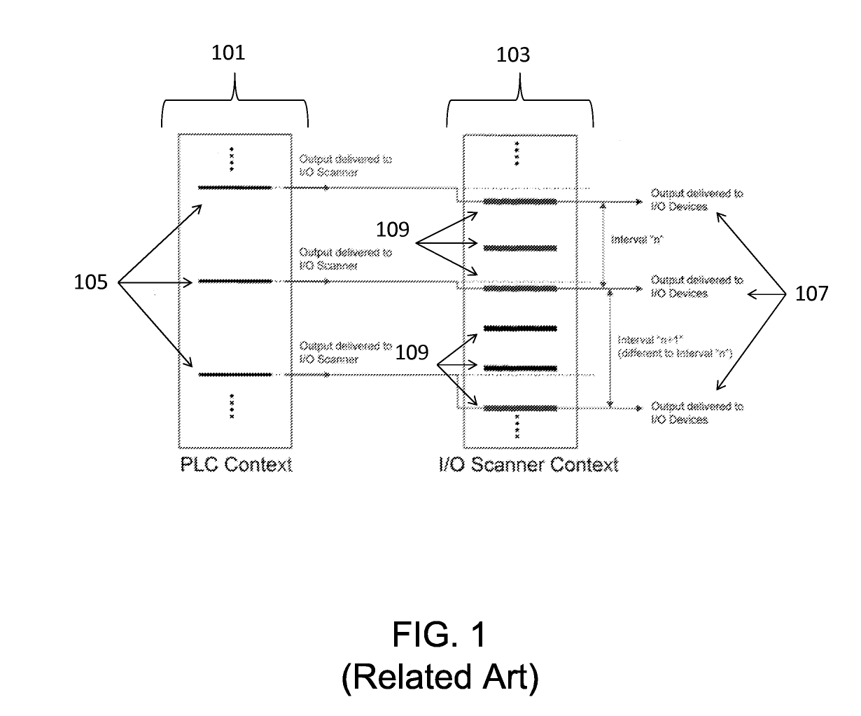

The steps that follow in the Figures may be implemented by one or more of the components in FIGS. 1 and 2 and/or other components, including other computing devices.

In accordance with various aspects of the disclosure, methods, computer-readable media, and apparatuses are disclosed for synchronizing the transmission of output data to I/O devices immediately after solving for the output data.

To implement this solution, a user may use an enhanced synchronized communication device 201 configured to run computer-executable program instructions related to each step of an output data synchronization process. Device 201 may interface with different types of network devices (e.g., devices 301), including embedded devices with no user interface, such as those typically found in automation control systems. In addition, enhanced synchronized communication device 201 may use a variety of networking protocols and procedures for synchronizing the transmission of output data to I/O devices. For example, device 201 may use the Common Industrial Protocol (CIP) in an Ethernet Industrial Protocol (EtherNet/IP) network, among other types of networking protocols.

In one embodiment, the enhanced synchronized communication device 201 may be a hardware module separate from but associated with the CPU of a PLC. In this embodiment, device 201 may communicate with the CPU via a backplane. The CPU may serve as a master and the enhanced synchronized communication device 201 may serve as the slave for communicating with I/O devices. In this regard, the CPU may implement various applications which process input data from one or more I/O devices to generate output data for at least one I/O device. More specifically, device 201 may probe various I/O devices (sensors, actuators, etc.) to obtain input data (e.g., read data, etc.) and may relay the input data to the CPU so that the CPU may solve for output data using the input data. Once the CPU has determined/generated the output data, the enhanced synchronized communication device 201 may be notified (e.g., by an interrupt, call back mechanism, function call, etc.). In servicing this notification, the output data may be sent to the appropriate I/O devices (e.g., write data, etc.) by using an application trigger of CIP.

For instance, an example control system may include a voltage sensor as an I/O device. In this example, assume that a motor connected to the sensor must be turned off if the voltage exceeds 10 V. Voltage data may be transmitted from the sensor to the enhanced synchronized communication device 201, which may relay this data to the CPU. The CPU may then process the data to determine if the voltage has exceeded the 10 V threshold. If it has, the CPU may relay a message (e.g., output data) to enhanced synchronized communication device 201, instructing the appropriate motor to shut off. Once device 201 receives this message, device 201 may recognize that the message includes output data for a given application and may use the associated application trigger feature of CIP to immediately forward the output data to the appropriate motor.

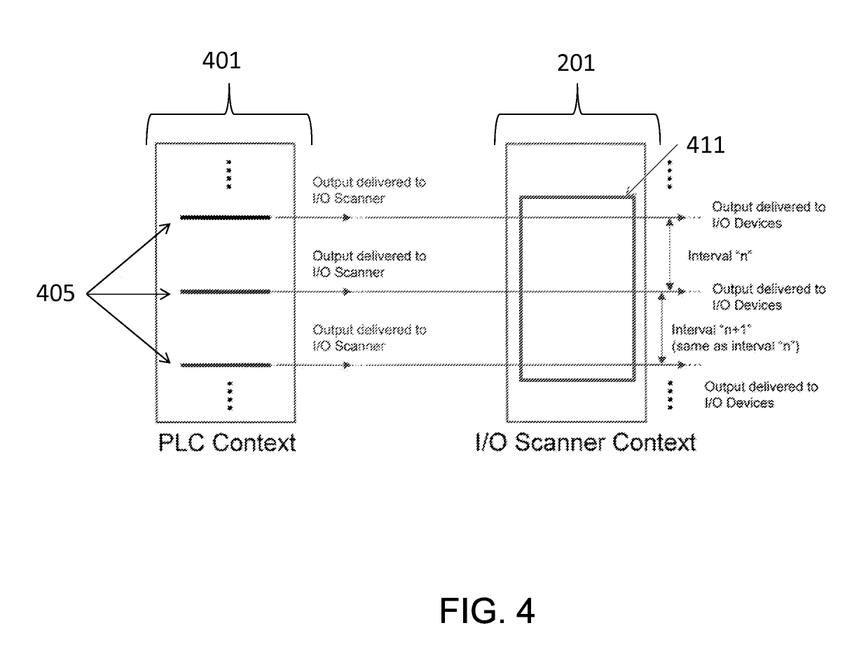

FIG. 4 shows a diagram of a control system for synchronizing the delivery of output data to I/O devices with the generation of this output data by a CPU associated with a PLC, in accordance with at least one aspect of the disclosure. FIG. 4 includes a PLC CPU 401 and an enhanced synchronized communication device 201 in communication over a backplane (not shown). The PLC CPU 401 and the enhanced synchronized communication device 201 may communicate over the backplane on an EtherNet/IP network using CIP. As shown in FIG. 4, PLC CPU 401 may generate output data at times 405 for delivery to an enhanced synchronized communication device 201. In particular, when the output data is ready, device 201 may be notified (e.g., by a call back mechanism, interrupt, function call, etc.). To service this notification, enhanced synchronized communication device 201 may include a service processor 411 that associates any given incoming output data message (e.g., messages at times 405 in FIG. 4) with the application trigger feature of CIP. Once the output data is associated with the application trigger feature of CIP, enhanced synchronized communication device 201 may immediately transmit the output data associated with the application trigger feature to the appropriate I/O devices downstream of device 201.

This process may remove possible jitter in output data delivery to I/O devices and, therefore, may make I/O scanning synchronized with a PLC scan (e.g., PLC output cycle) in control systems.

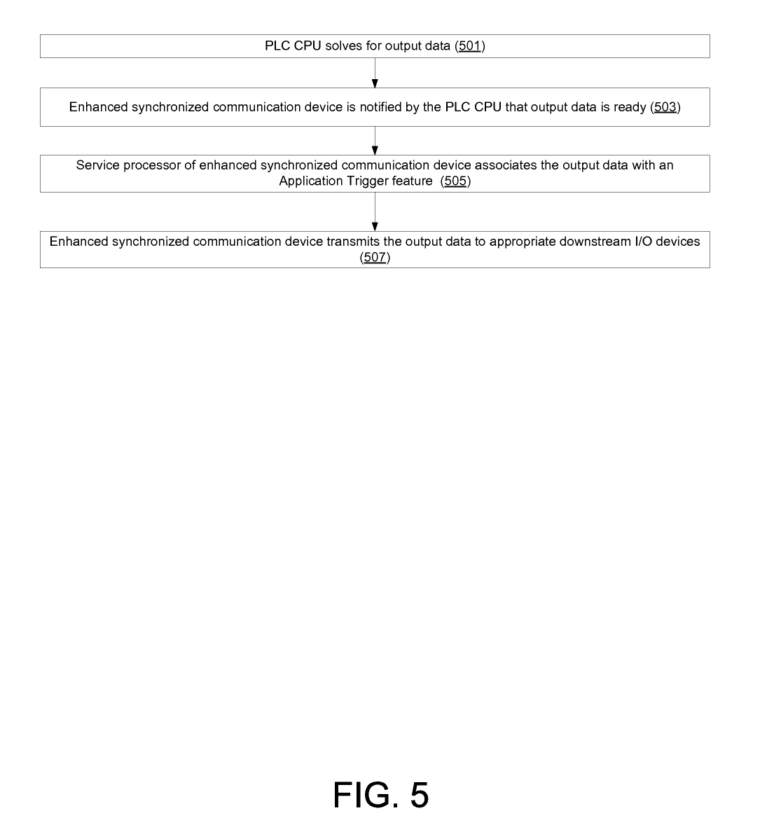

FIG. 5 shows an example flow diagram of steps performed for synchronizing the delivery of output data to I/O devices with the generation of this output data by a CPU associated with a PLC, in accordance with at least one aspect of the disclosure. The process in FIG. 5 may start out at step 501 where the CPU of a PLC may generate output data to be transmitted to one or more downstream I/O devices. The CPU may implement predefined logic that evaluates input data from the I/O devices to generate the output data.

Once the output data has been generated, an enhanced synchronized communication device (e.g., device 201) may be notified (e.g., via a call back mechanism, interrupt, and/or a function call, etc.) by the PLC CPU that output data is ready for delivery in step 503. In servicing this notification, a service processor of the enhanced synchronized communication device may then associate the output with an application trigger feature of the CIP in step 505. The association of the application trigger feature with the output data may trigger the enhanced synchronized communication device to transmit the output data to the appropriate downstream I/O devices in step 507.

In this way, output data may be transmitted to I/O devices immediately after the output data has been generated by the PLC CPU (or when the output cycle for the PLC is complete) and the time at which the output data is transmitted to the I/O devices may not depend on the cycle time of a COM module. The transmission of output data to I/O devices using this process may also be independent of the type of backplane bus used to communicate between the PLC CPU and the enhanced synchronized communication device 201.

The systems and methods disclosed herein may be applied to a variety of industries that would benefit from synchronized output data, including waste water applications, mining, minerals, and materials applications, and process critical applications such as those in the food and beverage industry and the oil and gas industry.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A non-transitory computer-readable storage medium having computer-executable program instructions stored thereon that when executed by a processor, cause the processor to perform steps comprising:
receiving, via a backplane located on a network using a network protocol, input data from a synchronized communication device in communication with a plurality of input/output (I/O) devices;
using predefined logic, solving for output data to be transmitted to at least one of the plurality of I/O devices; and
transmitting the output data to the synchronized communication device via the backplane,
wherein the output data is configured to be associated with a trigger mechanism that transmits the output data to the at least one of the plurality of I/O devices immediately after the output data is transmitted to the synchronized communication device.

2. The non-transitory computer-readable storage medium of claim 1, wherein the network comprises an Ethernet Industrial Protocol (EtherNet/IP) network.

3. The non-transitory computer-readable storage medium of claim 2, wherein the network protocol comprises Common Industrial Protocol (CIP).

4. The non-transitory computer-readable storage medium of claim 3, wherein the trigger mechanism is an application trigger feature of the CIP.

5. The non-transitory computer-readable storage medium of claim 1, wherein the output data is transmitted to the synchronized communication device upon completion of an output cycle of the processor.

6. The non-transitory computer-readable storage medium of claim 1, wherein the output data is transmitted to the synchronized communication device when the output data indicates a change in a value of at least one variable included in the output data.

7. The non-transitory computer-readable storage medium of claim 1, wherein the plurality of I/O devices include motors, switches, and sensors.

8. The non-transitory computer-readable storage medium of claim 1, wherein the network comprises an automation control network including at least one programmable logic controller (PLC).

9. A computer-assisted method comprising:
receiving, via a network protocol on a network with a backplane, a plurality of output data to be transmitted to at least one of a plurality of input/output (I/O) devices;
using a service processor of a synchronized communication device, associating the plurality of output data with a service that triggers immediate transfer of the plurality of output data to the at least one of the plurality of I/O devices; and
using the service executed through the service processor, transmitting the plurality of output data to the least one of the plurality of I/O devices.

10. The computer-assisted method of claim 9, wherein the network protocol comprises Common Industrial Protocol (CIP).

11. The computer-assisted method of claim 10, wherein the network comprises an Ethernet Industrial Protocol (EtherNet/IP) network.

12. The computer-assisted method of claim 11, wherein the service comprises an application trigger feature of the CIP.

13. The computer-assisted method of claim 9, wherein the plurality of output data is received from a central processing unit (CPU) associated with a programmable logic controller (PLC).

14. The computer-assisted method of claim 13, wherein the plurality of output data is received when the plurality of output data indicates a change in a value of at least one variable included in the plurality of output data.

15. The computer-assisted method of claim 13, further comprising: using the service processor, detecting when an output cycle of the PLC has been completed.

16. The computer-assisted method of claim 15, wherein the plurality of output data is received upon the completion of the output cycle associated with the PLC.

17. An apparatus comprising:
a processor; and
a memory storing computer-readable instructions that, when executed by the processor, cause the apparatus at least to perform:
receiving, via a Common Industrial Protocol (CIP) over an Ethernet Industrial Protocol (EtherNet/IP) network, a plurality of output data to be transmitted to at least one of a plurality of input/output (I/O) devices;
associating the plurality of output data with an application trigger service of the CIP, wherein the application trigger service triggers immediate transfer of the plurality of output data to the at least one of the plurality of I/O devices; and
using the application trigger service, transmitting the plurality of output data to the least one of the plurality of I/O devices.

18. The apparatus of claim 17, wherein the apparatus further performs: receiving a plurality of input data configured to be transmitted to a central processing unit (CPU) associated with a programmable logic controller (PLC).

19. The apparatus of claim 18, wherein the apparatus further performs: transmitting the plurality of input data to the CPU.

20. The apparatus of claim 17, wherein the apparatus further performs: processing an interrupt that indicates that the plurality of output data is ready to be transmitted to the at least one of the plurality of I/O devices.
